(19) United States
(12) Patent Application Publication
(10) Pub. No.: US 2012/0206805 A1
(43) Pub. Date: Aug. 16, 2012

(54) NANOWIRE GRID POLARIZERS AND METHODS FOR FABRICATING THE SAME

(75) Inventors: Xiansheng Meng, Durham, NC (US); Zhilian Zhou, Pittsburgh, PA (US); Douglas Mar, Chapel Hill, NC (US); Ginger Rothrock, Cary, NC (US); Paul Drzaic, Morgan Hill, CA (US)

(73) Assignee: LIQUIDIA TECHNOLOGIES, INC, DURHAM, NC (US)

(21) Appl. No.: 13/390,848

(22) PCT Filed: Aug. 17, 2010
(86) PCT No.: PCT/US10/45792

§ 371 Date: May 2, 2012

Related U.S. Application Data
(60) Provisional application No. 61/234,976, filed on Aug. 18, 2009.

(51) Int. Cl. G02B 5/30; B29C 33/38

(52) U.S. Cl. 359/487.03; 264/219

(57) ABSTRACT

A polarizer including a substrate sheet configured with grid elements on at least a first surface, wherein the grid elements have a height to width aspect ratio of at least 1.5:1, and metal coupled with the grid elements, wherein the metal comprises a height to width aspect ratio greater than the aspect ratio of the grid elements of the substrate.

### CROSS-REFERENCE TO RELATED APPLICATIONS

This application claims the benefit of U.S. Provisional Patent Application No. 61/234,976, filed Aug. 18, 2009, which is incorporated herein by reference in its entirety.

### STATEMENT REGARDING FEDERALLY SPONSORED RESEARCH

This invention was made, in part, with United States Government support under cooperative agreement number 70NANB7H7026 awarded by the National Institute of Standards and Technology (NIST). The United States government may have certain rights in this invention.

### TECHNICAL FIELD OF THE INVENTION

The present invention relates, in some embodiments, to polarizer devices for polarizing light and methods for fabricating the same. More particularly, the present invention relates, in some embodiments, to nanowire grid polarizers and methods for fabricating the same.

### INCORPORATION BY REFERENCE

Each reference identified herein is hereby incorporated by reference as if set forth in its entirety.

### BACKGROUND

Polarized light is utilized in numerous applications including liquid crystal displays (LCDs), projection systems, photographic equipment and other optical systems. The term “polarized light” refers to the particular state of a propagating electromagnetic wave, and there are several different types of polarization. Generally, light emitted from most sources is “randomly polarized”, which means that there is no particular polarization state associated with the wave—at any given time, or position, the polarization state of the wave changes in a rapid and unpredictable manner. Randomly polarized light is sometimes referred to as “unpolarized light”; these terms are used herein interchangeably. Light can become polarized by transmission through certain types of material, or by reflecting off surfaces under certain conditions. This polarized light can be “linearly polarized”, which means that the electric field component of the electromagnetic wave is constrained to oscillate in a single plane orthogonal to the propagation direction. It is also possible to generate circularly polarized light, or alternatively elliptically polarized light, which means that the electric field component of the electromagnetic wave rotates with some periodicity as the wave propagates. For the purposes of this text, we will define the term “polarized” to refer any type of polarized light, including linear, circular or elliptical, among others.

For light of one particular (linear) polarization, there exists another linear polarization rotated at 90 degrees to the first polarization. In devices, it is common to refer to polarization states as s-polarized or p-polarized, which refers to the polarization direction relative to a surface interacting with the wave. Here, p-polarized light has its electric field direction oriented to lie parallel to the interacting surface, while s-polarized light has its electric field direction oriented perpendicular to the surface. While this designation is common for light impinging onto a surface at an angle, for light propagating normal to a surface, the selection of p and s polarizations is arbitrary.

To produce polarized light from an unpolarized light source, the electromagnetic waves of a particular polarization state, must be separated out from the unpolarized light. Devices that separate out a particular polarization are called polarizers. Linear polarizers are used to obtain a beam of light generally having a single (linear) polarization, or linearly polarized light. Such devices typically function by allowing transmission of electromagnetic waves of a single polarization while absorbing or reflecting electromagnetic waves of other orientations. Ideally for many applications, a linear polarizer should be configured to permit high transmission of the light having a desired polarization (which we arbitrarily define herein as p-polarization) while preventing or reflecting light having the opposite orientation (which we define here as the s-polarization).

As widely known by those skilled in the art, different parameters may be used to describe the performance of a linear polarizer including the transmission coefficient through the polarizer of p-polarized light at normal incidence (Tp), the transmission coefficient through the polarizer of s-polarized light at normal incidence (Ts), the ratio of Tp to Ts or “contrast ratio” (K), and the reflection coefficient of the s-polarized light (Rs). In general, the higher the values of Tp and K, the better the efficiency and performance of the polarizer. For example, a high performance polarizer should ideally have a Tp value of at least about 80% and a K value of at least 100 to about 1000.

Other desirable qualities of a polarizer include large area, scalability, thinness, flexibility, wide acceptance angle while maintaining polarization state, low cost, thermal stability, photochemical stability, humidity stability, compatibility with a wide choice of materials, and the ability to be integrated into or onto other optical components. Polarizers are being adopted in displays of sizes ranging from handheld devices to large outdoor displays; in general the ability to create high quality polarizer films of large scale in a cost-effective manner will enable these large-area applications. Additionally, the industry is moving towards thinner, cheaper, and higher performance displays. Incorporating a polarizer film that is thin, or is multifunctional (e.g., also includes a prism film, diffuser, wide viewing angle, or other functionality) into the display stack helps meet some of the industry targets. Polarizing film with one or more of these properties can be used to reduce the complexity, size and weight, and cost of optical systems in displays and other applications.

Examples of polarizers known in the art include birefringent crystal polarizers, pile-of-plate polarizers, specialized prisms, multilayer laminated film polarizers, dichroic polarizers, cholesteric polarizers, and wire grid polarizers, such as those described in U.S. Pat. No. 6,208,463, which is incorporated herein by reference in its entirety. While some of these polarizers work by absorbing one polarization of incoming randomly polarized light, others operate by reflecting the unwanted polarization.

Wire grid polarizers are preferable to other forms of polarizers because they can possess excellent optical characteristics such as, for example, high transmission of one polarization and high reflection of the perpendicular polarization, a wide bandwidth over which the transmission and reflection spectra are relatively featureless, and a wide angular acceptance. Furthermore, wire grid polarizers may be made on thin, flexible substrates that can be easily integrated into LCD and other displays. Other examples of wire grid polarizers are disclosed in, for example, U.S. Pat. Nos. 7,570,424; 7,375,887; and 6,710,921, each of which is incorporated herein by reference in its entirety.

Wire grid polarizers belong to a broader class of optical elements often referred to as subwavelength optical elements, or “subwavelength optics”. Here, the feature sizes of the elements are smaller than the wavelength of the electromagnetic radiation they control. There are multiple form factors of subwavelength optical elements, including lines, grids, and other more complex structures. The ability of subwavelength optics to transmit or reflect different wavelengths can be set through the design of the size and shape of the individual elements.

Hertzian, or wire grid polarizers (WGPs), have been known for over 100 years, and have been successively used in polarization applications at radio and infrared wavelengths. The history of nanowire gratings demonstrates that performance (e.g., high polarization contrast and low loss) and scalability (e.g., small wire sizes, large area manufacturing) have proven to be the greatest challenges for micron-scale and smaller structures. The state of the art of nanotechnology has matured sufficiently, and applications at visible wavelengths are now tenable; broadband visible (450-700 nm) applications require wire dimensions and interwire spacing on the order of 150 nm or less. Commercial versions of micron-sized metallic wires on glass coupons are available from Moxtek, Inc. (MICROWIREST™ polarizers). They are useful for display projection apparatus, and polarization devices for fiber optic communications, although the size is too small for large area applications like direct-view flat panel display applications, and the geometry of the wires is limited.

A major technological limitation is creating controlled nanowire structures in a repeatable way and over large areas with high fidelity and low cost. The current patterning techniques for nanowire grids with pitch <150 nm rely on methods that have been leveraged for semiconductor process technologies that approach sizes nearing 200 mm and are limited to patterning on semiconductor wafers. Serial patterning methods such as electron beam lithography have good linewidth resolution and line positioning, but require prohibitively long times to write large areas. Field stitching is also an issue. There have been some recent advances in the field with tools called “Distributed variable axis” ebeam (either DIVA or DIFA) in the literature, which claim write speeds of 1 cm²/sec write time for an array of 100×100 beams, however this technology is still in its infancy. Interference lithography methods take advantage of the fact that the desired pattern is a linear grating, and therefore can be exposed by the standing wave pattern that occurs at the mutual intersection of two monochromatic ultraviolet laser beams. While this is a very good idea in theory, technically in practice it is extremely difficult to achieve the required precision over large areas because of aberrations or defects in the laser optics and stringent requirements on positioning and process stability. Scalable extensions to larger areas encounter difficulties. For applications not requiring such extreme fidelity, other non-lithographic fabrication methods may be available. U.S. Patent Application Publication No. US 2006/0273067, which is incorporated herein by reference in its entirety, suggests a method using plasma modification of a wave ordered (pattern formation) amorphous Si layer. This allows subwavelength (<150 nm) patterns with significant optical anisotropy, but issues with the pattern quality (e.g., presence of defects, coherent line placement) may severely limit applications.

### SUMMARY OF EMBODIMENTS OF THE INVENTION

The present invention, according to some embodiments, includes mold-based fabrication methods which provide unique and attractive approaches to fabricate large areas of nanopatterned wires at scale. In some embodiments, the process starts with a master template that can be produced using techniques listed above. In some embodiments, the master is molded, creating a negative image. Then, according to some embodiments, the mold is used to replicate the master structure repetitively. A process according to embodiments of the present invention preserves the expensive, high fidelity original master template and transfers its surface pattern onto the replicate thereby enabling volume fabrication of the nanowire pattern in a variety of materials at reasonable cost. In addition, the master template pattern can be tiled, in some embodiments, to create a large area, which in turn can be molded and replicated to produce large area wire grid polarizers.

The present invention, in some embodiments, includes wire grid polarizers made by mold-based fabrication methods. According to some embodiments, the present invention includes a polarizer for polarizing electromagnetic waves. In some embodiments, the present invention includes a polarizer for polarizing light in the visible to near-visible spectrums. In some embodiments, the present invention includes a polarizer for polarizing light in the infrared spectrum.

In some embodiments, the present invention includes a nanowire grid polarizer (NWGP). In some embodiments, a polarizer according to the present invention includes a substrate and a plurality of grid elements. In some embodiments, the grid elements are substantially parallel. In some embodiments, the grid elements are spaced substantially evenly.

In some embodiments, the present invention includes subwavelength optical elements in which the spacing between the elements can be controlled either passively (such as in response to a change in temperature) or actively (such as in response to an applied electric field). In this way, the wavelengths and/or polarizations transmitted or reflected by the subwavelength optics can vary in a useful and predictable way.

A polarizer according to some embodiments of the present invention includes a substrate sheet configured with grid elements on at least a first surface, and metal coupled with the grid elements. In some embodiments the grid elements have a height to width aspect ratio of at least 1:1. In some embodiments, the aspect ratio of the grid elements of the substrate sheet is greater than about 1.5:1. In some embodiments, the aspect ratio of the grid elements of the substrate sheet is greater than about 3:1. In some embodiments, the aspect ratio of the grid elements is greater than about 4:1. In some embodiments, the metal includes a height to width aspect ratio greater than the aspect ratio of the grid elements of the substrate. In one embodiment of the present invention, a polarizer includes a substrate sheet and grid elements positioned on the substrate sheet, wherein the grid elements include metal and have an aspect ratio of greater than about 2:1 and a pitch of less than about 150 nanometers.

In some embodiments, the grid elements of the substrate sheet are angled relative to vertical. In some embodiments, the grid elements are configured between about 5 degrees from vertical and about 50 degrees from vertical. In some embodiments, the grid elements are configured between about 10 degrees from vertical and about 40 degrees from vertical. In some embodiments, the grid elements are configured between about 20 degrees from vertical and about 30 degrees from vertical.

A polarizer in accordance with some embodiments includes a footprint of greater than about 900 square centimeters. In some embodiments, the polarizer includes a plurality of polarizers. In one embodiment, a seam between adjacent polarizers is less than about 500 nm horizontally and less than about 500 nm vertically. In other embodiments, the polarizer includes a plurality of polarizers and a seam between adjacent polarizers is a feathered seam. In some embodiments, the feathered seam has a transition zone of greater than about 10 micrometers.

A process for forming a polarizer according to one embodiment of the present invention includes providing a polymer mold on a web, fabricating a replicate inverse structure of the mold into a substrate material, wherein the replicate structure includes grid elements having an aspect ratio of greater than about 1.5:1 and a pitch less than about 150 nanometers, and metalizing the grid elements such that the metalized portion of the grid elements has an aspect ratio greater than the aspect ratio of the grid elements. In an alternative embodiment, instead of a polymer mold on a web, a patterned drum is provided wherein the patterned drum includes the structure to be replicated onto the substrate material.

In another embodiment, a process for forming a polarizer includes providing a substrate sheet and molding onto at least one surface of the substrate sheet at least two metal based grid elements comprising an aspect ratio greater than about 2:1 and a pitch of less than about 150 nanometers. In variation of this embodiment, molding includes providing a patterned template having an inverse pattern to the pattern of grid elements, depositing a metal solution into the pattern on the patterned template, hardening the metal solution in the pattern on the patterned template to form the metal based grid elements, and removing the patterned template from the grid elements. In some embodiments, the patterned template includes a web based mold or a patterned drum.

Other embodiments of the present invention include an infrared reflecting device. In one embodiment, an infrared reflecting device in accordance with the present invention includes a first set of grid elements, wherein the grid elements comprise metal and have an aspect ratio of greater than about 1.5:1 and a pitch between about 500 nanometers and about 1000 nanometers, a second set of grid elements, wherein the grid elements comprise metal and have an aspect ratio greater than about 1.5:1 and a pitch between about 500 nanometers and about 1000 nanometers, and wherein the first set of grid elements are positioned orthogonal to the second set of grid elements such that infrared radiation is reflected from the device. In one embodiment, the first set of grid elements are configured on a first substrate and the second set of grid elements are configured on a second substrate.

Other embodiments of the present invention include an electromagnetic switch. In one embodiment, an electromagnetic switch includes a substrate configured with a first patterned layer of metal and a second patterned layer of metal, wherein the first patterned layer of metal and the second patterned layer of metal are configured into sub-wavelength geometries, wherein the substrate has a first configuration in a first environment and a second configuration in a second environment, and wherein the first patterned layer of metal and second patterned layer of metal are optically coupled in the first configuration and not optically coupled in the second configuration. In one embodiment, the first environment includes a first temperature and the second environment includes a second temperature. In another embodiment, the first environment includes a material having a first dielectric constant positioned between the first patterned layer of metal and the second patterned layer of metal and the second environment includes a material having a second dielectric constant provided between the first patterned layer of metal and the second patterned layer of metal.

### BRIEF DESCRIPTION OF THE DRAWINGS

Reference is made to the accompanying drawings which show illustrative embodiments of the present invention and which should be read in connection with the description of the invention.

FIG. 1 shows a top view of a polarizer in accordance with an embodiment of the present invention;

FIG. 2 shows a cross-sectional side view of a polarizer in accordance with an embodiment of the present invention;

FIG. 3 shows a cross-sectional side view of a polarizer in accordance with another embodiment of the present invention;

FIG. 4 shows a top view of a tiled polarizer in accordance with an embodiment of the present invention;

FIG. 5 shows a top view of a tiled polarizer in accordance with another embodiment of the present invention;

FIG. 6 shows a stacked polarizer configuration in accordance with an embodiment of the present invention;

FIG. 7 shows a polarizer in accordance with another embodiment of the present invention;

FIG. 8 shows a polarizer in accordance with yet another embodiment of the present invention;

FIGS. 9A-9C are graphs showing the transmission performance of polarizers made in accordance with an embodiment of the present invention;

FIGS. 10A-10B are graphs showing the transmission performance of polarizers made in accordance with another embodiment of the present invention;

FIG. 11 shows a switching device in accordance with an embodiment of the present invention;

FIG. 12 shows a switching device in accordance with another embodiment of the present invention;

FIGS. 13A-D show example structures made in accordance with an embodiment of the present invention;

FIGS. 14A-B are graphs showing the performance of example devices made in accordance with an embodiment of the present invention;

FIGS. 15A-D show alternative embodiments of alternative metal deposition and their corresponding effects; and

FIG. 16 shows the performance of a device in accordance with another embodiment of the present invention having.

### DETAILED DESCRIPTION OF EMBODIMENTS OF THE INVENTION

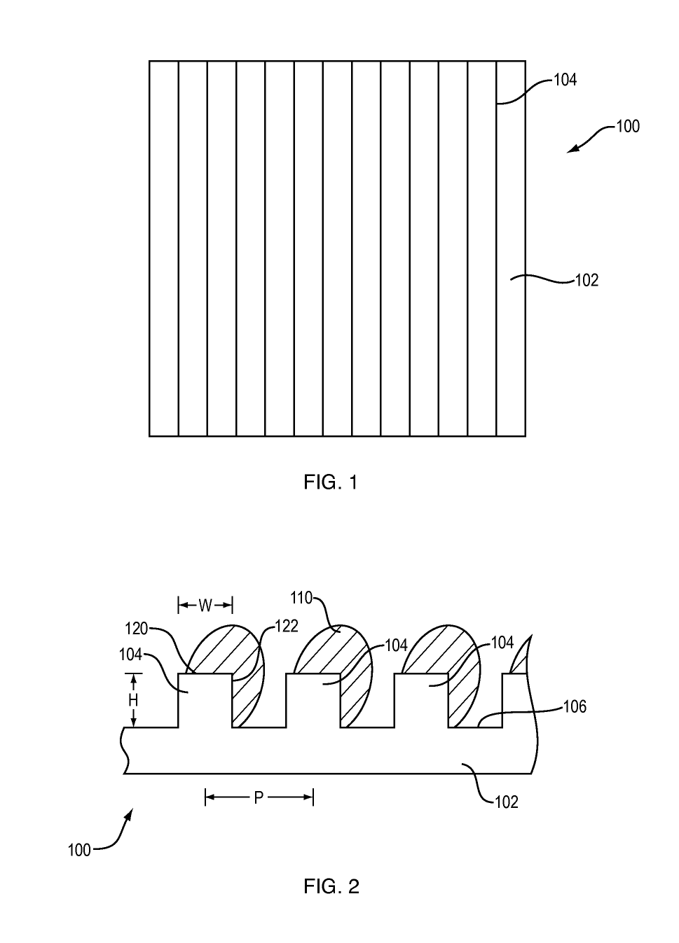

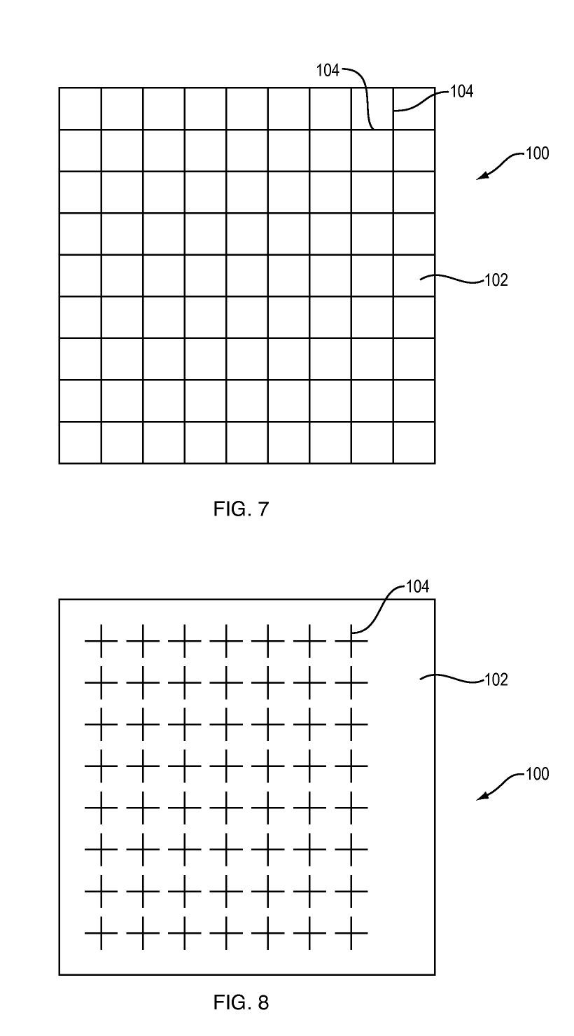

FIG. 1 shows a polarizer 100 in accordance with an embodiment of the present invention. Polarizer 100 generally includes a substrate 102 and a plurality of grid elements 104. Grid elements 104, in some embodiments, include projections which extend from substrate 102. In some embodiments, grid elements 104 include elongated projections which extend from substrate 102. In the embodiment shown in FIG. 1, for example, grid elements 104 are in the form of substantially parallel lines or wires (e.g., nanowires). In alternative embodiments, grid elements 104 may be perpendicularly arranged, for example, as shown in FIG. 7. In yet other embodiments, grid elements 104 may include closely spaced discontinuous (e.g., broken) lines or wires, for example, as shown in FIG. 8.

According to the embodiment shown in FIG. 2, which shows a cross-sectional view of a polarizer in accordance with one embodiment of the present invention, each grid element 104 includes a width W and extends from a surface 106 of the substrate 102 at a height H, wherein the H:W ratio is referred to as the aspect ratio of the grid elements. Preferably, the grid elements 104 are spaced substantially evenly along substrate 102 at a pitch P equal to the distance from one point of one grid element 104 to the corresponding point of an immediately adjacent grid element 104 (e.g., the distance between center points of two adjacent grid elements 104 or distance between leading edges 108 of two adjacent grid elements). In some embodiments, the grid elements 104 are molded metal based grid elements and in alternative embodiments, the grid elements 104 may or may not be integral with substrate 102 and further include a metallic component 110. The metallic component 110 may, in some embodiments, cover the top portion 120 of the grid elements 104, one side 122 of the grid elements 104, or some combination of the side or sides and/or top of grid elements 104. In some embodiments the grid elements 104 are substantially parallel over large distances (e.g., about the entire length of grid elements 104). In some embodiments, it is less critical that the metallic features (e.g., metallic component 110) exist as long, unbroken lines. It is possible, in some embodiments, to generate a strong polarization effect if there are small breaks along a particular metallic grid element 104. Moreover, if there are breaks, it is possible to have the position of the next grid element offset laterally somewhat from the previous grid element, as long as the grid elements remain substantially parallel to other grid elements.

Substrate 102, according to some embodiments, may be constructed of any suitable material that permits transmission of the polarized light of the wavelength of interest. For example, substrate 102 in alternative embodiments may be made from glass, polymers, films, or other materials that are substantially transparent to the wavelength of light of interest, such as visible, infrared, or the like. Common visible polarizing film substrates which may be used in accordance with embodiments of the present invention include glass, tri-acetyl cellulose (TAC), cyclic olefin polymer (COP), polycarbonate, polysulfone, and polyethersulfone. In another embodiment, substrate 102 includes polyester and polyethylene naphthalate film. In another embodiment, the substrate 102 includes retardation film. In some embodiments, the retardation film is configured to “retard” or shift a component of light to convert, for example, elliptical polarized light into linear polarized light. In some embodiments, the retardation film is configured to optically compensate for a phase difference caused by a change in viewing angle, for example, when used in a display. The selection of materials for this application will be appreciated by one of ordinary skill in the art and can be selected and modified as needed for alternative embodiments. Substrate 102, in some embodiments, may be substantially rigid. In other embodiments, substrate 102 may be substantially flexible.

Substrate 102 can have an overall two-dimensional size or footprint that is virtually any two-dimensional shape such as, for example, rectangular, square, circular, triangular, hexagon, octagon, crescent, or another two-dimensional of interest for a given application. In some embodiments, the overall footprint of substrate 102 can be less than 100 square millimeters to greater than 100 square meters, depending on the desired application. The polarizing device can also be fabricated on a flexible substrate such that it can be applied to a light source having a round, curved, cylindrical, or the like shape. Generally, as described herein and in the references incorporated herein by reference, the origin of the grid element structures are formed from technologies in the semiconductor industry such as etching, e-beam lithography, and the like into a silicon or other master template. The applicants' related art further described below teaches how to take the original grid line structures in a master template fabricated by conventional techniques with their limited footprint and rigid material limitations and fabricate therefrom high precision replicates in polymeric and other materials. In some embodiments, the present invention builds on the applicants' related art, including tiling multiple small footprint sized components into large footprint dimension devices with minimal seams between adjacent patterned areas and includes metallization for polarization devices.

In some embodiments, substrate 102 and/or grid elements 104 are constructed using Pattern Replication In Non-wetting Templates (PRINT®) technology and techniques, for example, as described in the applicants' co-pending U.S. patent application Ser. Nos. 10/572,764 (published as U.S. Patent Application Publication No. 2007/0254278); 11/825,482 (published as U.S. Patent Application Publication No. 2009/0165320); 10/589,222 (published as U.S. Patent Application Publication No. 2007/0275193); 12/063,284 (published as U.S. Patent Application Publication No. 2009/0281250); 10/583,570 (published as U.S. Patent Application Publication No. 2009/0028910); 11/921,614 (corresponding to International Publication No. WO2007/024323); 11/633,763 (published as U.S. Patent Application Publication No. 2008/0131692); 12/250,461 (published as U.S. Patent Application Publication No. 2009/0098380); and 61/120,327 and 12/630,569 (published as U.S. Patent Application Publication No. 2010/0173113), each of which is incorporated herein by reference in its entirety. PRINT® technology is molding technology, which in one embodiment, is based on a family of polymer, FLUOROCUR® resin series, molding materials, which for example include the fluoropolymer materials (e.g., perfluoropolyether) described in the applicants' co-pending U.S. patent applications listed above. In some embodiments, these materials are low surface energy polymer materials exhibiting thermal and chemical stability with surface energies ranging from about 10 to about 22 mN/m. In some embodiments of this process, a master template made by photolithography or other precision patterning technique is used to provide the basis of highly defined nano- or micro-structures. FLUOROCUR® resin in its prepolymer liquid form may then applied to the master and polymerized in place to form a mold with a highly precise negative image of the original master. The mold lifts easily and cleanly from the master without the need for surface treatment due to the incredibly low surface energy of the FLUOROCUR® materials. The replicate materials may then be applied to the mold. This material can be organic materials such as UV-polymerizable resins, thermally polymerizable resins, polymerizable resins filled with non-reactive components, thermoplastics, polymer melts, polymers in solution, liquid metals, powders, metal nanoparticles, inks, colloidal suspensions of particles or powders, or inorganic materials such as sol-gel precursors, etc. When the mold is applied, capillary action forces the replicate material to fill the mold, which, depending on material composition can be assisted by heat and/or pressure. The replicate material is then hardened using a variety of techniques and the mold is removed from the replicas. This process may be used, in some embodiments, in a continuous roll to roll manufacturing process. In alternative embodiments, the roll to roll drum can be configured as the mold (in some embodiments from the FLUOROCUR® materials) with the negative image of desired features and used to form the materials into the desired pattern on the substrate.

In other embodiments, molds used in the present invention are constructed from non-FLUOROCUR® materials. In some embodiments, the molding material includes PDMS (poly dimethyl siloxane); hPDMS (“hard” poly dimethyl siloxane); PET (polyethylene terephthalate); and/or other suitable polymeric materials, such as, for example, those described in the co-pending U.S. patent applications listed above and incorporated herein by reference. In some embodiments, the molding material has a surface energy less than about 25 mN/m. In some embodiments, the molding material has a surface energy less than about 20 mN/m. In some embodiments, the molding material has a surface energy less than about 15 mN/m. In some embodiments, the molding material has a surface energy less than about 10 mN/m. In some embodiments, the molding material has a surface energy less than about 5 mN/m. In some embodiments, the molding material has a surface energy ranging from about 5 to about 25 mN/m. In some embodiments, the molding material has a surface energy ranging from about 5 to about 20 mN/m. In some embodiments, the molding material has a surface energy ranging from about 5 to about 15 mN/m. In some embodiments, the molding material has a surface energy ranging from about 5 to about 10 mN/m. In some embodiments, the molding material has a surface energy ranging from about 10 to about 25 mN/m. In some embodiments, the molding material has a surface energy ranging from about 10 to about 20 mN/m. In some embodiments, the molding material has a surface energy ranging from about 10 to about 15 mN/m. In some embodiments, the molding material has a surface energy ranging from about 15 to about 25 mN/m. In some embodiments, the molding material has a surface energy ranging from about 15 to about 20 mN/m.

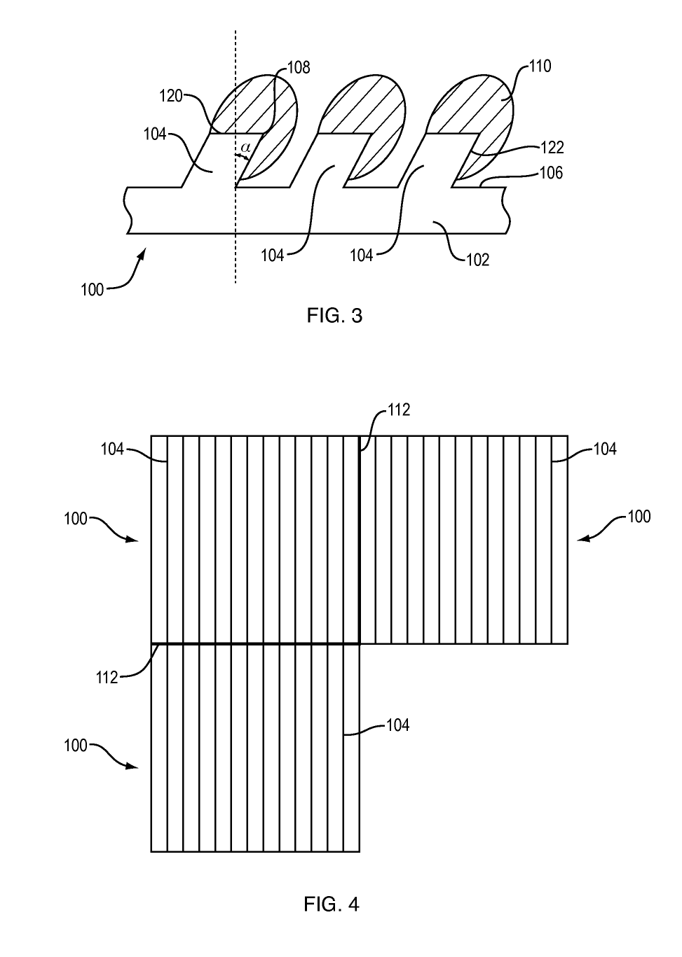

In the embodiment shown in FIG. 2, grid elements 104 each have a substantially rectangular cross-section. In another embodiment, grid elements 104 each have a substantially curved top portion or have sides that come to a substantial ridgeline. In another embodiment, as shown in FIG. 3, the grid elements 104 are pillars that are leaning or curved in a preferential direction. In other embodiments, the structures form a substantial right triangle with one vertical edge. While other shapes are not enumerated herein, the present invention contemplates any shape that can be fabricated into a master template through the current and future lithography, etching, or similar methods which are well known in the art and can be replicated with the applicants' co-pending techniques, materials, and methods incorporated herein by reference.

Grid elements 104, in some embodiments, may be constructed of the same materials as substrate 102. In some embodiments, grid elements 104 are attached to or adhered to substrate 102. In some embodiments, grid elements 104 are formed integrally with substrate 102. In some embodiments, grid elements 104 are formed by etching material away from substrate 102. In some embodiments, grid elements 104 are molded onto substrate 102. In some embodiments, grid elements 104 are metal based grid elements patterned directly on substrate. In some embodiments, the metal based grid elements may be formed from one or more metals, for example, aluminum, gold, silver, platinum, copper, zinc, indium, tin, and/or a combination thereof.

As shown in FIG. 2, grid elements 104 may be substantially perpendicular to surface 106 of substrate 102 such side portion 122 extends substantially perpendicular from surface 106. In some embodiments, side portion 122 is not substantially perpendicular to surface 106. In some embodiments, grid elements 104 may be angled away from normal (e.g., tilted) with respect to substrate 102, for example, as shown in FIG. 3. In some embodiments, grid elements 104 are configured such that leading edges 108 and side portion 122, or long cross-sectional axis of grid elements 104 if grid element has a curved or other non-linear leading edge 108, is angled away from the vertical by an angle α greater than about 0 degrees. In some embodiments, angle α greater than about 5 degrees. In some embodiments, angle α greater than about 10 degrees. In some embodiments, angle α greater than about 15 degrees. In some embodiments, angle α greater than about 20 degrees. In some embodiments, angle α greater than about 25 degrees. In some embodiments, angle α greater than about 30 degrees. In some embodiments, angle α greater than about 35 degrees. In some embodiments, angle α greater than about 40 degrees. In some embodiments, angle α greater than about 45 degrees. In some embodiments, angle α greater than about 50 degrees. In some embodiments, angle α is from about 1 degree to about 50 degrees. In other embodiments, angle α is from about 5 degrees to about 45 degrees from the vertical. In other embodiments, angle α is from about 10 degrees to about 40 degrees from the vertical. In other embodiments, angle α is from about 15 degrees to about 35 degrees from the vertical. In other embodiments, angle α is from about 20 degrees to about 30 degrees from the vertical. In some embodiments, the inventors of the present application found the unexpected result that providing the grid element at an angle α greater than 0 degrees from vertical provides greater access to one lengthwise side of the grid element such that during metallization the metal has a greater surface area to contact. In embodiments where substrate 102 and/or grid elements 104 are constructed of a flexible material, angle α should be understood to mean the angle when polarizer 100 is in an unflexed state. In alternative embodiments, the angle of grid elements 104 can be preset for a given application such that as flexible substrate 102 is positioned on a curved or angled element (curved window, lens, or the like for example) the grid elements 104 result in a predetermined orientation relative to the angled element.

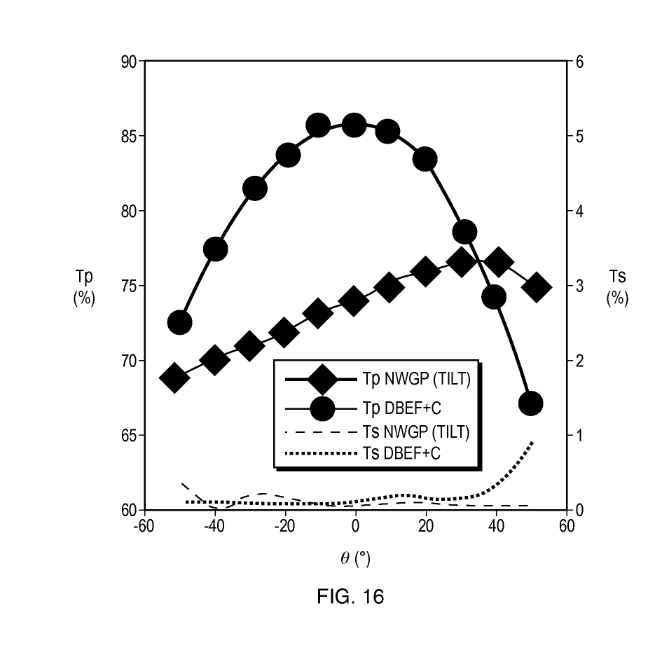

As to be described further, the present invention provides the unexpected results that having a metalized or metal structure with a high height to width aspect ratio (and the proper pitch) yields better performance. In some embodiments, the angle of the grid elements is a further parameter to adjust, along with pitch and metallization, in maximizing the performance of a wire grid polarizer. The present invention provides the result that a metallized or metal structure with the proper aspect ratio and pitch can be used to provide better performance by providing angular control. A structure with grid elements 104 with aspect ratio larger than about 1.5 have preferred orientations relative to substrate 102 for proper operation. For example, if the desired operation is to control light perpendicular to the substrate 102, then for maximum performance the major axis (longest dimension) of the metal cross-section should lie in the direction perpendicular to the substrate and the minor axis (shortest dimension) should lie in the direction along the substrate and perpendicular to the wires. For operation with light at different angles to the substrate, the axes of the metal grid elements should be oriented so that the major axis lies along the direction of the incoming light and the minor axis is oriented approximately perpendicular to this direction. FIG. 16 shows optimal performance at 30 degrees from normal as represented by the curve with diamond shaped markers.

In some embodiments, for example wherein a polarizer device of the present invention is used in a display (e.g., liquid crystal display), advantages to angling the metal and/or grid elements include preferential viewing at angles other than where the viewer is perpendicular (e.g., zero degrees) to the display. For example, in one embodiment, a polarizer substrate with angled metal or grid elements can be positioned on an overhead display such that viewers looking at the display at a given angle (for example, 30 degrees for a screen positioned on a wall higher than the viewer) will be viewing the display at the optimal angle. It will be appreciated that not all the grid elements of a given polarizer need to be oriented at the same angle, rather, in some embodiments, there can be zones within the polarizer with different grid element angles such as to maximize the viewing of a given screen (e.g. large screen) from a given point of view. In other manifestations, there are 3D displays that rely on having different elements of the polarizer possess different linear polarizations (such as small, thin stripes of alternating polarization).

Angling the grid elements, in some embodiments, yields a variable polarizer or reflector for light incident on the device from different angles. In some embodiments, a polarizer device according to the present invention only allows transmission of light incident on the device at selected angles while substantially reflecting or absorbing light at all other angles. For example, in one embodiment, a substrate with grid elements can be positioned on a roof or window of a building or vehicle. As such, the transmission and reflection of sunlight incident on the window or roof can be modulated depending on the incident direction of light. For example, the light (visible and/or IR wavelengths) on a window can be reflected or absorbed at high angles (e.g., at mid-day) reducing the amount of heat that enters a building or vehicle. In some instances, the grid elements allow for light transmission only at substantially low angles (for example, −90 to +30 degrees where −90 is straight down and +90 is straight up) and reflection or absorption at greater angles (for example, from +30 to +90 degrees). Therefore, the present invention, in some embodiments, provides a device to polarize or reflect or absorb incident light between predetermined angles.

Grid elements 104, in some embodiments, can have a length that substantially matches the length of substrate 102. Because the dimensions (e.g., width, height, and length) of grid elements 104 in some embodiments are initially set by the size of the original structures fabricated into the master via etching, e-beam lithography, laser cutting, or the like, the length of the grid elements 104 are relatively fixed due to the size of the available master, for example, less than about 450 millimeters in one embodiment.

The present invention incorporates by reference the applicants' co-pending U.S. patent application Ser. No. 12/630,569, filed Dec. 3, 2009, (published as U.S. Patent Application Publication No. US 2010/0173113) and U.S. Patent Application No. 61/120,327, filed Dec. 5, 2008, and, in some embodiments, includes tiling techniques taught in the incorporated references to tile two or more substrates 102 containing grid elements 104 into large area, large footprint, polarization or reflecting devices of the present invention.

Utilizing the applicants co-pending methods, materials, and roll-to-roll manufacturing devices, substrates 102 of the present invention, when tiled together can have an effective footprint having a widths of greater than 10 centimeters, greater than 50 centimeters, or greater than 100 centimeters and lengths of tens to hundreds to thousands of meters. In some embodiments, a drum component of the roll-to-roll manufacturing device can be configured with the pattern of interest to be transferred, such as inverse grid elements. A substrate carrying a curable polymer material or curable or hardenable metal can be nipped with the patterned drum, a source for curing or hardening the material applied to or near the nip-point and therefore a length of substrate is formed with continuous grid elements thereon.

In some embodiments, the substrate footprint has an area greater than about 100 square centimeters. In some embodiments, the substrate footprint has an area greater than about 200 square centimeters. In some embodiments, the substrate footprint has an area greater than about 300 square centimeters. In some embodiments, the substrate footprint has an area greater than about 400 square centimeters. In some embodiments, the substrate footprint has an area greater than about 500 square centimeters. In some embodiments, the substrate footprint has an area greater than about 600 square centimeters. In some embodiments, the substrate footprint has an area greater than about 700 square centimeters. In some embodiments, the substrate footprint has an area greater than about 800 square centimeters. In some embodiments, the substrate footprint has an area greater than about 900 square centimeters. In some embodiments, the substrate footprint has an area greater than about 1000 square centimeters. In some embodiments, the substrate footprint has an area greater than about 2000 square centimeters. In some embodiments, the substrate footprint has an area greater than about 5000 square centimeters. In some embodiments, the substrate footprint has an area greater than about 1 square meter. In some embodiments, the substrate footprint has an area greater than about 5 square meters. In some embodiments, the substrate footprint has an area greater than about 10 square meters. In some embodiments, the substrate footprint has an area greater than about 100 square meters.

In some embodiments of a visible spectrum polarization device, the grid elements 104 have a pitch of less than about 150 nanometers. In other embodiments of a visible spectrum polarization device, the grid elements 104 have a pitch of between about 30 and about 150 nanometers. In other embodiments of a visible spectrum polarization device, the grid elements 104 have a pitch of between about 50 and about 100 nanometers. In other embodiments of a visible spectrum polarization device, the grid elements 104 have a pitch of between about 50 and about 75 nanometers. According to some embodiments of a visible spectrum polarization device, the grid elements 104 have a width of between about 20 to about 80 percent of the pitch. According to other embodiments of a visible spectrum polarization device, the grid elements 104 have a width of between about 25 to about 60 percent of the pitch. According to some embodiments of a visible spectrum polarization device, the grid elements 104 have a width of between about 25 to about 50 percent of the pitch. According to some embodiments of a visible spectrum polarization device, the grid elements 104 have a width of between about 25 to about 40 percent of the pitch. According to some embodiments of a visible spectrum polarization device, the grid elements 104 have a width of between about 30 to about 50 percent of the pitch.

It has been found that, in some embodiments, a higher aspect ratio, where “aspect ratio” is taken to mean “(grid element height)/(grid element width),” is generally better for the optical performance of the polarizer in that it allows one to obtain good Tp and good K performance simultaneously. For a given pitch, increasing height improves the contrast while only modestly degrading transmission Tp in some embodiments. For a given height, improving (shortening) the pitch and the wire width simultaneously benefits the transmission slightly and greatly improves the contrast in some embodiments.

In some embodiments, grid elements 104 each have a height to width aspect ratio of about 1:1 to about 10:1, about 20:1, about 25:1, about 30:1, about 35:1, about 40:1, about 45:1, or about 50:1. In some embodiments, grid elements 104 each have a height to width aspect ratio of about 2:1 to about 9:1. In some embodiments, grid elements 104 each have a height to width aspect ratio of about 3:1 to about 7:1. In some embodiments, grid elements 104 each have a height to width aspect ratio of about 4:1 to about 6:1. In some embodiments, grid elements 104 each have a height to width aspect ratio less than about 1:1. In some embodiments, grid elements 104 each have a height to width aspect ratio greater than about 1:1. In some embodiments, grid elements 104 each have a height to width aspect ratio greater than about 1.5:1. In some embodiments, grid elements 104 each have a height to width aspect ratio greater than about 2:1. In some embodiments, grid elements 104 each have a height to width aspect ratio greater than about 2.5:1. In some embodiments, grid elements 104 each have a height to width aspect ratio greater than about 3:1. In some embodiments, grid elements 104 each have a height to width aspect ratio greater than about 3.5:1. In some embodiments, grid elements 104 each have a height to width aspect ratio greater than about 4:1. In some embodiments, grid elements 104 each have a height to width aspect ratio greater than about 4.5:1. In some embodiments, grid elements 104 each have a height to width aspect ratio greater than about 5:1. In some embodiments, grid elements 104 each have a height to width aspect ratio greater than about 5.5:1. In some embodiments, grid elements 104 each have a height to width aspect ratio greater than about 6:1. In some embodiments, grid elements 104 each have a height to width aspect ratio greater than about 6.5:1. In some embodiments, grid elements 104 each have a height to width aspect ratio greater than about 7:1. In some embodiments, grid elements 104 each have a height to width aspect ratio greater than about 7.5:1. In some embodiments, grid elements 104 each have a height to width aspect ratio greater than about 8:1. In some embodiments, grid elements 104 each have a height to width aspect ratio greater than about 8.5:1. In some embodiments, grid elements 104 each have a height to width aspect ratio greater than about 9:1. In some embodiments, grid elements 104 each have a height to width aspect ratio greater than about 9.5:1. In some embodiments, grid elements 104 each have a height to width aspect ratio greater than about 10:1. In some embodiments, a grid element with a high aspect ratio refers to a grid element with a height to width aspect ratio of at least about 2:1. In some embodiments, a grid element with a high aspect ratio refers to a grid element with a height to width aspect ratio of at least about 3:1.

Materials suitable for the grid elements 104 according to some embodiments of the present invention include polymer materials, glasses, ceramics, inorganic materials, metals, and porous or other composite materials. In some embodiments, materials suitable for the grid elements 104 have a given set of optical properties, including transmission generally greater than about 85 percent in visible range and refractive index less than about 1.7.

According to some embodiments where the grid elements 104 are polymeric or non-metal, grid elements 104 are metalized to include a metallic component 110 which covers at least a portion of each grid element 104. The metallic component 110, in some embodiments, interacts with the electromagnetic waves of the source light beam to generally pass light having a polarization oriented perpendicular to the length of the grid elements and reflect light having a polarization oriented parallel to the length of the grid elements. Metals useful for the metallic component 110 according to some embodiments include aluminum, gold, silver, platinum, copper, zinc, indium, tin, combinations thereof, and other metals suitable in the art.

In some embodiments, metalized grid elements can be created by first patterning polymer grid elements, preferably with a high aspect ratio, onto a substrate, then performing electroplating, metal deposition, or electroless plating to add a metallic coating on the polymer grid elements. In some embodiments, the metal layer is subsequently etched to create isolated metalized grid elements.

In some embodiments of the present invention, the metallic component 110 is applied to grid component 104 using deposition. In some embodiments, the metallic component 110 is applied in between the grid element 104 by electroless or other plating technique. In some embodiments where the metallic component 110 is deposited, the metallic component 110 is deposited through an oblique or angle metal deposition process. In some embodiments, the angle relative to perpendicular for depositing the metal is selected between about 0 degrees (i.e., perpendicular to the substrate) and about 40 degrees. In some embodiments, the angle for depositing the metal is selected between about 15 degrees and about 35 degrees. In some embodiments, the angle for depositing the metal is selected between about 20 degrees and about 30 degrees. According to the present invention, the angle for depositing the metal is determined at least in part by the aspect ratio of the grid element and the cross-sectional shape of the grid element 104. In some embodiments, if the grid element 104 has an aspect ratio of about 1.5:1 then the metal is deposited from an angle of about 34 degrees. In other embodiments, if the grid element 104 has an aspect ratio of about 2:1, then the metal is deposited from an angle of about 27 degrees. In yet further embodiments, if the grid element 104 has an aspect ratio of about 3:1, then the metal is deposited from an angle of about 18 degrees.

According to an embodiment of the present invention, the metallic component 110 of the polarizer device 100 has a cross-sectional profile that includes an inner surface that substantially conforms to grid element 104 and a convex outer surface opposite the inner surface (See FIG. 2 for example). The inner surface, in some embodiments, is a substantially concave surface. In some embodiments, metallic component 110 partially surrounds a grid element 104. In some embodiments, metallic component 110 contacts at least two sides of a grid element 104. In some embodiments, the metallic component 110 extends around at least a top portion 120 and side portion 122 of a grid element 104 and may, for example, have a curved cross-sectional profile that is substantially shaped like an apostrophe or other tapered structure, as shown in FIG. 2. According to a preferred embodiment, the metallic component 110 is deposited on top portion 120 of a grid element 104 and extends down side portion 122 of the grid element 104, thereby forming a tilted apostrophe shape. A curved (e.g., apostrophe-shaped) metallic component 110, in some embodiments, may be formed by angle metal deposition as described above. It has been found that, in some embodiments, a curved (e.g., apostrophe-shaped) metallic component 110 is less susceptible to resonance effects than a metallic component having rectangular cross-sectional profile, particularly at short wavelengths.

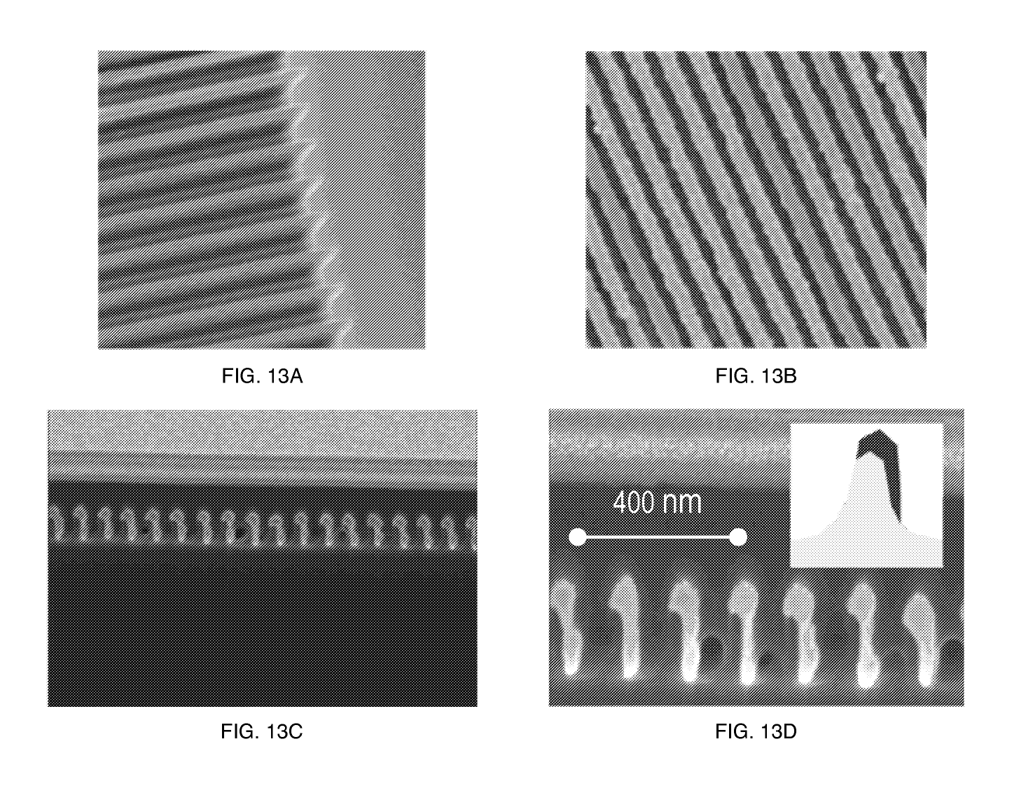

In some embodiments, the present invention includes a semi-curved metallic component 110 having a wider top portion than bottom portion as shown in FIGS. 13C and 13D, or apostrophe shape (where top refers to the upper portion in the Figures and bottom refers to the lower portion in the Figures). The apostrophe shaped metallic component 110 has a high aspect ratio of between about 2 to about 25 with a width of between about 20 nanometers to about 50 nanometers and a height of between about 100 nanometers to about 500 nanometers. In some embodiments, the aspect ratio of the metallic component 110 (e.g., metallic component having an apostrophe or other non-uniform shape) is defined as the ratio of the height of the metallic component 110 to the width of the metallic component 110 measured at half the height of the metallic component 110 (e.g., Hm/Wm as shown in FIG. 3). In alternative embodiments, the present invention includes a curved (e.g., apostrophe-shaped) metallic component 110 having a high aspect ratio of between about 3 to about 8 with a width of between about 30 nanometers to about 40 nanometers and a height of between about 150 nanometers to about 250 nanometers.

According to some embodiments of the present invention, the height of the metallic component 110 is greater than the height of the grid element 104. In some embodiments, the aspect ratio of the metal component is between about 1:1 and about 10:1. More preferably, the aspect ratio of the metal component is between about 2:1 and about 7:1. In alternative embodiments, the aspect ratio of the metal component is between about 4:1 and about 5:1. In some embodiments, increasing the aspect ratios of the metal component increases performance of the polarizer device by maintaining high Tp and low Ts at shorter wavelengths. Aspect ratio for the metal component is, as described above, measured as the (height)/(width at half height).

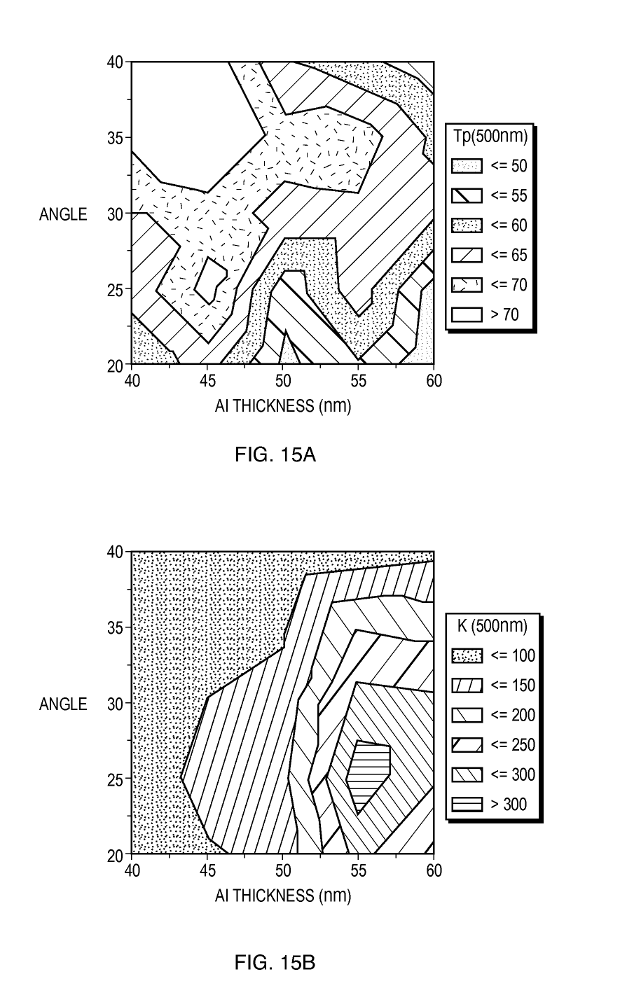

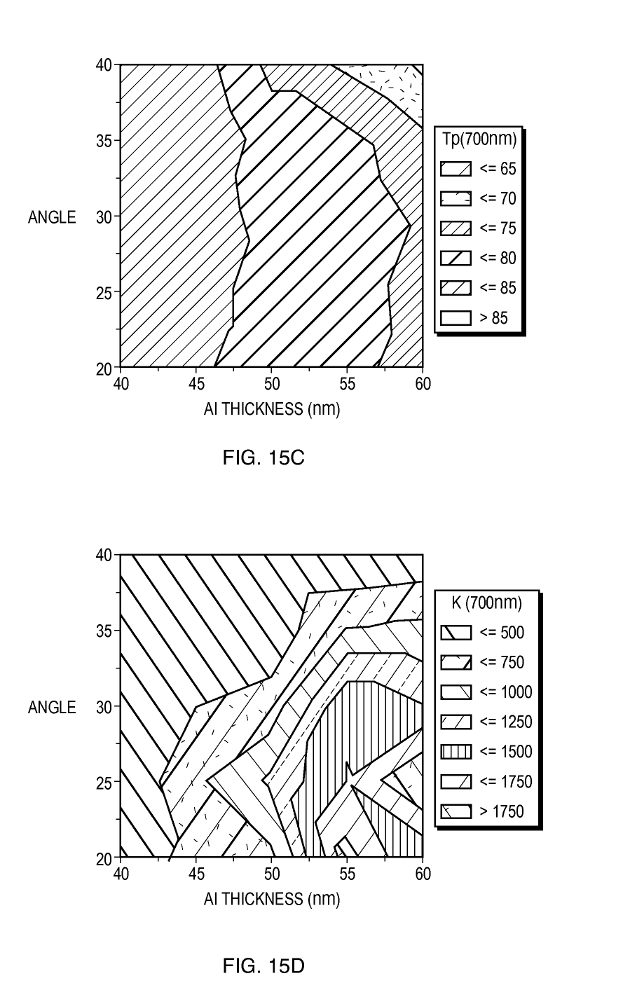

In some embodiments, the cross-sectional profile of the metallic component for a grid element can be shaped by varying the metal evaporation angle and thickness. A profile with a high aspect ratio (narrow width, large height of the metal component) is generally desirable for good polarizer performance, according to some embodiments. This profile is achieved in some embodiments by depositing the metal under the proper conditions (deposition thickness and angle from which the metal is deposited) onto the grid elements. For high aspect ratio grid elements, according to some embodiments, the evaporation angle is approximately chosen such that the metal deposits over the entire height and/or surface of the sidewall of the grid elements (e.g., side 122 of FIGS. 2 and 3), providing maximum height of the metal component. In some embodiments, the exact metal deposition conditions for best performance depend on structural and optical parameters of the underlying surface. FIGS. 15A-D illustrate alternative evaporation conditions on the polarizing performance of an example grid of aluminum (Al) lines having the parameters of about 144 nm pitch, about 40% duty cycle, about 60 nm line width, and about 210 nm line height. As used herein, duty cycle refers to the ratio of the grid line width to the pitch. FIGS. 15A and 15B show the contour plots of Tp and K at the blue side of the spectrum. In order to achieve high Tp, small Al thickness and larger evaporation angle are desired as demonstrated in FIG. 15A. Larger evaporation angle tends to correspond to narrower width of the evaporated Al wire; narrower Al wires will give higher transmission for both Tp and Ts. On the other hand, small evaporation angle and thicker Al layer lead to high contrast ratio. These effects are observed in the red side of the spectrum as well. But the long wavelength side is more forgiving as shown in FIGS. 15C and 15D. In almost the entire evaporation window explored, Tp is about 70% or above and K is above about 100. In most cases, K is above about 500 for the sample structure tested.

In alternative embodiments of the present invention, the grid elements 104 are formed from a metal material and are directly patterned in a mold (or drum) during a molding process, thereby eliminating the need for an additional metal component. According to such embodiments, the aspect ratio, height, width and other parameter arguments described herein apply equally to the metal grid elements directly patterned onto a substrate. In some embodiments, metal grid elements are created by molding metal directly onto the substrate. While bulk metallic materials are very hard to process, there are alternative ways to pattern metals directly. In one embodiment, direct molding involves patterning dispersions of metal nanoparticles, “liquid metal” and low melting solder. While most bulk metallic materials have very high melting temperature, some metals such as indium and metal alloys have lower melting temperatures (50-200° C.), and have attracted interest with the unique combination of accessible processing temperatures and metal-like characteristics. Liquid metals typically melt at 400-600° C., while the low-melting solders or fusible alloys have melting temperatures from about 50-300° C. These temperatures are much more accessible compared to typical melting temperatures for metals at 1000° C. and above, but they still represent a challenge when used in conjunction with organic materials, such as those used to construct the molds. In some instances, metals have very high surface energy and may not naturally wet the mold surface, unlike organic materials. In some embodiments, the mold surface can be chemically modified to allow wetting. For example, existence of thiol functionalities on the organic surface of a mold in some embodiments has proven to help the wetting properties between metals and the organic surface. Further examples can be found in “Microsolidics: Fabrication of Three-Dimensional Metallic Microstructures in Poly(dimethylsiloxane)”, J. Adv. Materials, vol 19, page 727-733 (2007) by A. C. Siegel, D. A. Bruzewicz, D. B. Weibel, G. M. Whitesides, which is incorporated herein by reference in its entirety.

In some embodiments, the grid elements 104 are nanowires (e.g., metal lines) that are created by patterning of metal nanoparticles. In some embodiments this process includes molding metal nanoparticles through liquid dispersion or a thermal process and annealing the resulting patterned metallic features to create bulk lines. The synthesis of metal nanoparticles of desired size and/or shape have been explored for gold, silver, platinum, and other metals. While very small metal clusters (<˜50 metal atom) act like large molecules, large clusters (>˜300 atoms) exhibit characteristics of a bulk sample. Between these extremes lie materials with intermediate properties. Since in some embodiments isolated metal lines are desired with a pitch less than 200 nm (<100 nm line width for a 50% duty cycle), it is preferable in these embodiments to start with metal nanoparticles with a diameter smaller than about 30 nm in some embodiments and in other embodiments less than about 10 nm to optimize the packing density in the mold recesses. The literature on this topic reports that the clusters of metal atoms are stabilized to a remarkable degree by a monolayer of stabilization agents and the particles are readily prepared in large quantities.

The metal nanoparticles in some embodiments can be molded either from a liquid dispersion or by a thermal process. In one embodiment, the metal nanoparticles can be dispersed into an organic solvent and molded using FLUOROCUR® molding materials or other suitable molding materials in a typical PRINT process as described above. FLUOROCUR® molding materials are chemically resistant and stable over most hydrocarbon-based organics. As would be apparent to those skilled in the art, the process of filling of the mold will depend on the specific physical structure, solvent, nanoparticle, and concentration, to name a few, and processing parameters such as temperature, speed, peeling angle can be optimized for each system.

Metal nanoparticles show large melting temperature depression due to the thermodynamic size effect. For example, bulk gold has a melting point of 1064° C., while approximately 2-3 nm sized gold nanoparticles start to melt at around 130-140° C. This temperature range is very compatible for Fluorocur materials, allowing for the use of a melt fill process according to embodiments of the present invention. Compared to molding of low melting solder, the metal nanoparticles in some embodiments are typically surface modified by organic materials, which make the system more suitable for the PRINT process requirements for surface properties for wetting and de-wetting.

In some embodiments, after metal nano-particles have been patterned, the linear metal features can be annealed or sintered to obtain bulk metal properties. The metal nanoparticles can be transformed from an insulator to a conductor in some embodiments after energy input by conductive heating, heating using radio frequency sources, heating caused by exposure to lamps, or laser irradiation. After annealing, the pattern lines should have similar properties as bulk metal. In some embodiments, after sintering at higher temperature, the metal nanostructured features may show tapered sidewalls or shrinkage due to removal of organic self-assembled monolayers on the surface of nanoparticles and increased mass density. Process conditions can be optimized to minimize the shrinkage factor of the lines; additionally this shrinkage factor can be factored into the master design as needed according to other embodiments.

In some embodiments, metal grid elements (e.g., nanowires or lines) can be patterned through the reduction of metal salt solutions or solutions of organometallic species directly in a FLUOROCUR® or other suitable polymer mold. In some embodiments of this approach, molds are filed directly with a mixture of reactants and the mold recesses will act as nano-reactors for the reduction reaction. In some embodiments, kinetics control is not as critical for particle size control, since the “particle” line will take on the shape of the linear recesses. The appropriate reaction mechanism and conditions should be selected to ensure that the reaction will not commence during mold fill and de-wetting. In some embodiments, the reaction can be triggered by some external parameters such as, for example, temperature, light, and/or radiation. In some embodiments, after the formation of metallic features in the mold, the nanowires can then be transferred to the substrate in regular arrays, directly from the mold. In one embodiment, the molding technique of the present invention can be used to pattern resist material directly onto a metallic substrate. Once the resist material is patterned onto the metallic substrate, the component can be subjected to an etching process, such as those known in the art, to fabricate a structured metallic component.

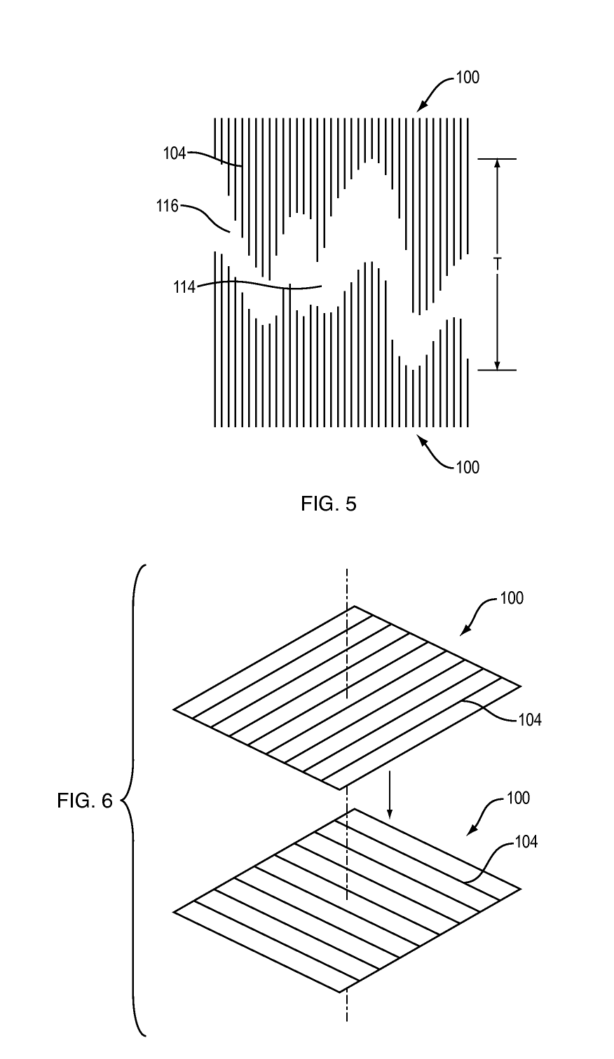

In another embodiment of the present invention, two or more polarizers 100 as described above may be combined or tiled to effectively produce a polarizer having a larger surface area, for example, as shown in FIGS. 4 and 5. Preferably the two or more polarizers 100 are combined or tiled such that all the grid elements 104 of the polarizers 100 are substantially parallel.

According to certain embodiments of the present invention as described herein, to fabricate a large scale polarizer of the present invention a large scale mold, continuous mold, or drum is fabricated in the inverse pattern sought for the grid elements. To fabricate a large scale mold, continuous mold, or drum in accordance with some embodiments, a small scale patterned area representing a single polarizer can be tiled into the larger area. The present invention, in some embodiments, draws upon the methods and systems described in U.S. Patent Application No. 61/120,327 and co-pending U.S. patent application Ser. No. 12/630,569 (published as U.S. Patent Application Publication No. US 2010/0173113) which are incorporated herein by reference in their entireties, to tile the small scale patterned area into a larger area mold or drum with minimal height and width seams between adjacent patterned areas. It is desirable to minimize seam dimensions, in some embodiments for example, in order to decrease visibility and/or noticeability of the seam between adjacent patterned areas.

Some embodiments of the present invention provides for a feathered (non-linear) patterned zone or seam between tiled polarizers, for example, as depicted in FIG. 5. In some embodiments, a feathered patterned zone 114 (non-linear seam) between tiled polarizers 100 decreases visibility and/or noticeability of the seam to a viewer between tiled areas. The feathered patterned zones between tiled polarizers 100, according to some embodiments, are fabricated according to the methods and systems described in U.S. Patent Application No. 61/120,327 and U.S. patent application Ser. No. 12/630,569 using patterned areas having non-linear edges 116 (e.g., curved, wavy, torn, scalloped, or the like). The resulting mold or drum fabricates an integral large scale patterned area polarizers with feathered transition zones between the uniform patterned areas. In some embodiments, the feathered transition zone has a variance from linear (e.g., width) T of between about 1 μm to about 1 cm. In some embodiments, the feathered transition zone has a variance from linear T of between about 1 μm to about 1 mm. In some embodiments, the feathered transition zone has a variance from linear T of between about 1 μm to about 100 μm. In some embodiments, the feathered transition zone has a variance from linear T of between about 1 μm to about 10 μm. In some embodiments, the feathered transition zone has a variance from linear T of between about 100 μm to about 1 mm. In preferred embodiments, the feathered transition zone has a variance from linear T of between about 1 mm and about 1 cm. In some embodiments, the feathered transition zone has a variance from linear T greater than about 1 μm. In some embodiments, the feathered transition zone has a variance from linear T greater than about 10 μm. In some embodiments, the feathered transition zone has a variance from linear T greater than about 100 μm. In some embodiments, the feathered transition zone has a variance from linear T greater than about 1 mm. In some embodiments, the feathered transition zone has a variance from linear T greater than about 1 cm. In some embodiments, the feathered transition zone has a variance from linear T less than about 1 cm. In some embodiments, the feathered transition zone has a variance from linear T less than about 1 mm. In some embodiments, the feathered transition zone has a variance from linear T less than about 100 μm. In some embodiments, the feathered transition zone has a variance from linear T less than about 10 μm. In some embodiments, the feathered transition zone has a variance from linear T less than about 1 μm.

In some embodiments, the grid elements of adjacent tiled polarizers fabricated from the large area mold, continuous mold, or drum described above are oriented substantially parallel with respect to neighboring grid elements such that the entire large area device transmits the same or substantially the same polarization of light.

In some embodiments, two or more polarizers 100 are joined or tiled together to form a larger footprint polarizer or reflector. In some embodiments, multiple polarization devices 100 can be joined by straight seams 112 wherein the polarizers 100 have substantially linear adjoining edges, for example as shown in FIG. 4. In one embodiment, the straight seam has a width less than about 1 micrometer. In one embodiment, the straight seam has a width less than about 750 nanometers. In one embodiment, the straight seam has a width less than about 500 nanometers. In one embodiment, the straight seam has a width less than about 250 nanometers. In one embodiment, the straight seam has a width less than about 200 nanometers. In one embodiment, the straight seam has a width less than about 150 nanometers. In one embodiment, the straight seam has a width less than about 100 nanometers. In one embodiment, the straight seam has a width less than about 75 nanometers. In one embodiment, the straight seam has a height less than about 1 micrometer. In one embodiment, the straight seam has a height less than about 750 nanometers. In one embodiment, the straight seam has a height less than about 500 nanometers. In one embodiment, the straight seam has a height less than about 250 nanometers. In one embodiment, the straight seam has a height less than about 200 nanometers. In one embodiment, the straight seam has a height less than about 150 nanometers. In one embodiment, the straight seam has a height less than about 100 nanometers. In one embodiment, the straight seam has a height less than about 75 nanometers.

The polarizer devices described above may be used, according to some embodiments of the present invention, in applications including LCDs and other displays, projection equipment, and other optical systems.

Infrared Application

In other embodiments of the present invention two or more polarizers 100 may be stacked together, for example, as shown in FIG. 6. In one embodiment, if two polarizers 100 are configured such that the grid elements 104 of one polarizer 100 are orthogonal to the grid elements 104 of the another polarizer 100, the polarizers 100 would block the transmission of a particular spectrum of light since all polarizations of the selected wavelengths would be reflected or absorbed. For example, in one embodiment, the grid elements 104 are arranged at a pitch of between about 200 nm and about 1000 nm so as to polarize only light in the infrared spectrum. In more preferred embodiments, the grid elements 104 of the infrared polarizing elements are arranged with a pitch of between about 500 nm and about 800 nm so as to polarize only light in the infrared spectrum. According to the present invention multiple infrared polarizer devices can be stacked in a configuration, such as for example, configuring two polarizing devices adjacent with grid elements orthogonal, that allows transmission of visible light while reflecting infrared light. An alternative reflecting device according to another embodiment of the present invention can be constructed from a single polarizer 100 having a substrate 102 having a single layer of orthogonally arranged grid elements 104, as illustrated in FIG. 7. In alternative embodiments, the grid elements can be two separate layers within a single substrate 102. In further alternative embodiments, the grid elements 104 can include incomplete wire lines (e.g., partial grids), as shown in FIG. 8.

An infrared reflecting device in accordance with embodiments of the present invention could be, for example, used in roofs, windows and coatings so as to reduce unwanted heating of buildings, vehicles, etc. As an exterior surface, a material contributes to a building's energy efficiency by proper management of the visible and infrared radiation that impinges upon it. A surface that reflects, rather than absorbs or transmits solar radiation generally will remain cooler and thereby reduce the cooling loads on the building air handling. Roofing materials with high specular (shiny) or diffuse (white) reflectance can remain relatively cool, but it is desirable to be able to selectively pass visible radiation to widen the choice of roof colors. The case of high transparency in the visible spectrum, with low transmission in the IR spectrum is also desirable for window applications as this provides for energy efficient windows. Thus, the desirable functional device can be described as a “hot mirror” or shortpass wavelength filter. Current high-quality hot mirror coatings are commercially made by deposition of dielectric layers onto glass, which can provide very high IR rejection, however, the devices are bulky and limited in area to less than about 1 square meter. There are other metallic or dielectric coatings that can be deposited onto glass to form so-called low e or spectrally-selective coatings, but these coatings typically only reject a limited portion of the infrared spectrum, or add undesirable absorption or coloration of visible light.

Structures described in accordance with embodiments of the present invention offer such functionality, for example, nanometer-scale metallic structures onto a non-conducting surface. The grid element patterns are selected to have useful wavelength-dependent properties, for example, grid elements formed of parallel conducting wires form reflecting polarizers but only for electromagnetic wavelengths longer than the wire spacing (e.g., pitch). In some embodiments, a wire mesh structure reflects long wavelength radiation while transmitting reasonable amounts of short wavelength radiation. For embodiments directed to a solar rejection filter, the transition region occurs in the region 800-1000 nm, implying a grid pitch less than about 200 nm. Although periodic metal patterns at this scale can be easily fabricated using traditional semiconductor lithography techniques, these methods are expensive ($100 s or $1000 s/m²) and limited to areas much less than about 1 square meter.

The PRINT technology described in this invention and incorporated by reference makes possible the fabrication of nanostructures for IR reflection over large (e.g., about 1 meter wide and hundreds of meters in length) with high fidelity. In some embodiments, structures beyond linear gratings suitable for the present invention include moth-eye textures and micron-scale lens arrays with precision corners and facet angles, both of which are known in the art and will be appreciated by one of skill in the art. These structures are used in some embodiments to manage the transmission of light through the device, and with proper design of the structure, the transmission and reflection properties can be controlled as a function of wavelength, or as a function of incident angle of electromagnetic radiation. Materials useful to some embodiments of the present invention have the proper electromagnetic performance in terms of IR reflection and visible transmission and the proper materials choice likely to permit robust service lifetimes in the field

Additional applications for an IR reflecting device according to the present invention include, in some embodiments, other surfaces where heat management is critical, including automobiles, lighting sources. In other embodiments, an IR reflecting device according to the present invention may be used in photo- or video graphic equipment that contain sensors (e.g., CCD or CMOS sensors) that may be sensitive to infrared light.

In further embodiments, the optical response of nanoscale structures is a sensitive function of distance, field, or dielectric constant between metallic elements. By purposefully modulating the distance or dielectric constant between individual metallic elements, dynamic (switching) capabilities can be obtained. This change can be driven by temperature (e.g. a phase change, or a differential thermal expansion in the polymer film), by a user-specified signal (e.g. an electrical voltage), or introduction of a material having a specific dielectric constant and can be reversible. A particularly attractive form of this modulation is when the spacing between two layers of patterned metal is increased slightly such that the two layers are either optically coupled or not optically coupled together. The electromagnetic coupling between the two layers can be very sensitive to the interlayer distance, and so a small change in the thickness or electrical properties of the intervening layer can have dramatic effects, such as a shift in the filter transition frequency, a deepening of an IR resonance, or switching from absorbing to reflecting a wavelength or wavelengths. Dynamic capabilities are also applicable to frequency selective surfaces (FSS)—based on the metal structure and thickness of the dielectric layer, the spectral absorption and therefore the spectral emissivity can be altered to absorb and emit at specific wavelengths. In one embodiment, emission can be tuned from a band of wavelengths about 6-8 μm to a band at about 8-14 μm.

Such effects can be used to selectively and controllably transmit or reflect a portion of the solar spectrum, in a relatively simple, robust package that can be scaled to high volumes. The choice of metallic pattern and size scale can be made to transmit certain wavelengths in the ultraviolet, visible, and infrared ranges, and to reflect certain other wavelengths in the ultraviolet, visible, and infrared ranges. With a change in structure caused by temperature, an active signal, or other means, the ranges of wavelengths transmitted and reflected can be varied.

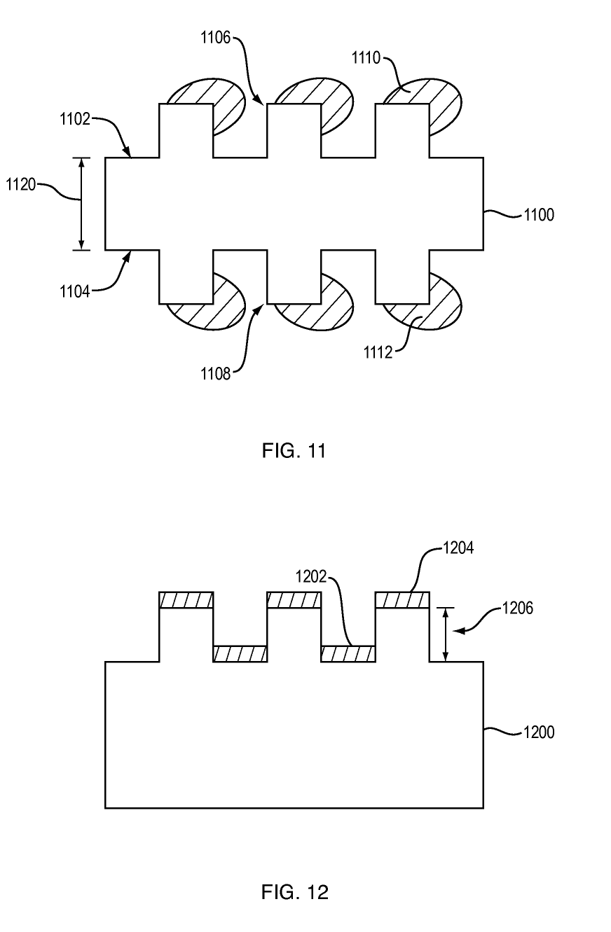

In some embodiments, the switching device includes a substrate having metallic components described herein on opposite surfaces as shown in FIG. 11. According to such embodiments, a distance 1120 between first metal components 1110 on a first surface 1102 and second metal components 1112 on second surface 1104 determines whether the switching device is a reflecting device or an absorbing device. As shown in FIG. 11, substrate 1100 includes a first surface 1102 and a second surface 1104 providing a specific thickness 1120 therebetween. In some embodiments, the first metal component 1110 is configured on first grid element 1106 and second metal component 1112 is configured on second grid element 1108. In alternative embodiments first metal 1110 and second metal 1112 components can be configured directly onto a flat first surface 1102 and second surface 1104, respectively. In some embodiments, the metal components (1110 1120, 1202 1204) are configured into sub-wavelength parameters as described in the present application and can be, for example, grid lines having the pitch, height, width, and aspect ratio as described herein, grid elements, or other appropriately designed geometric shapes. In some embodiments, material of substrate 1100 is selected to physically respond to environmental changes, such as for example temperature or radiation, by an amount to result in either absorbing light of a given wavelength or reflecting such light. In some embodiments, the physical response of substrate material results in a physical expansion or change of distance of thickness 1120 between the first and second metal components of less than about 200 nm to result in the switching effect. In other embodiments, substrate material is selected to change in thickness 1120 between first and second metal component between about 10 nm and about 100 nm to result in the switching effect of the opposing metal elements. In an alternative embodiment, as shown in FIG. 12, a switching device of the present invention can include substrate 1200 configured with a first layer of metal component 1202 and a second layer of metal component 1204 spaced a thickness 1206 apart.

According to alternative embodiments, the switching effect of the present invention can be a result of reversibly adding a material with a selected dielectric constant to the structured surface of substrate 1200. It will be appreciated by one of ordinary skill in the art that the dielectric constant of responsive material (e.g. a liquid or solid capable of undergoing a reversible change through environmental stimuli such as temperature, external stimuli, or the like) can be selected depending on the wavelength sought to be affected by the switching device and the material of the substrate.

One example of metallic structures for solar IR reflection comprise shaped metallic islands, or metal meshes with holes, with lateral pitch scales between about 200 nm and about 500 nm, and desirable resolution from about 10 nm to about 50 nm. Other designs comprise two-layer structures that can be built using a single metallization step performed on a molded structure, with the top and bottom patterns from the mold becoming metalized. In this way the relative registration of the elements can be quite high, as it is built into the stamp master, and preserved and scaled by the PRINT process.

The polymeric materials that possess the appropriate thermal expansion characteristics can comprise many different types of chemistries and morphologies. Generally, an elastomeric material is preferred that will reversible present a change in spectral response with a 10-20° C. change in temperature.

### Example 1

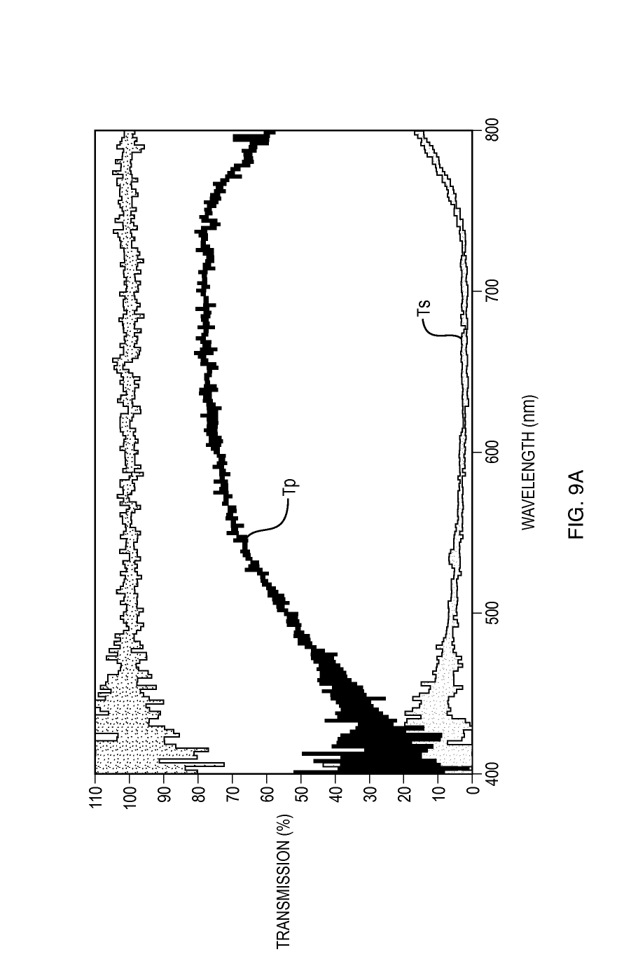

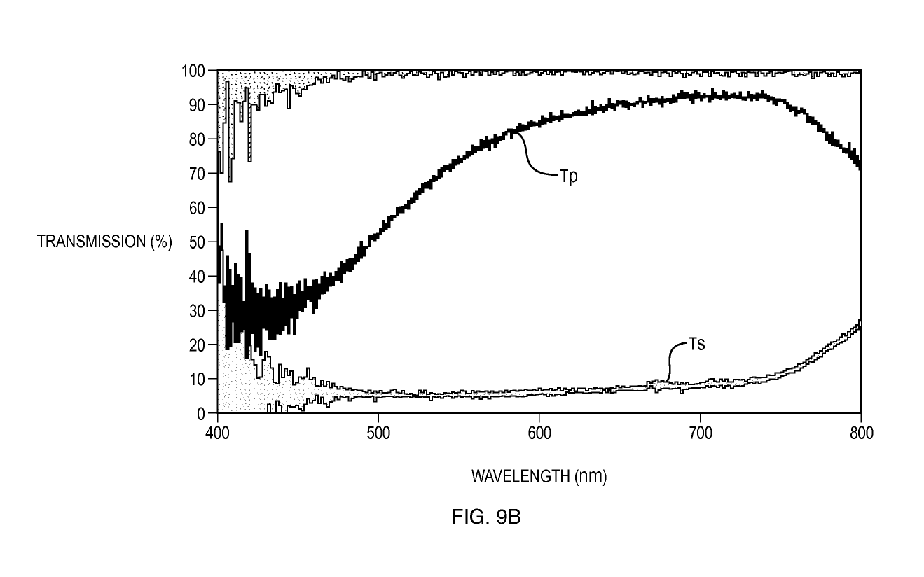

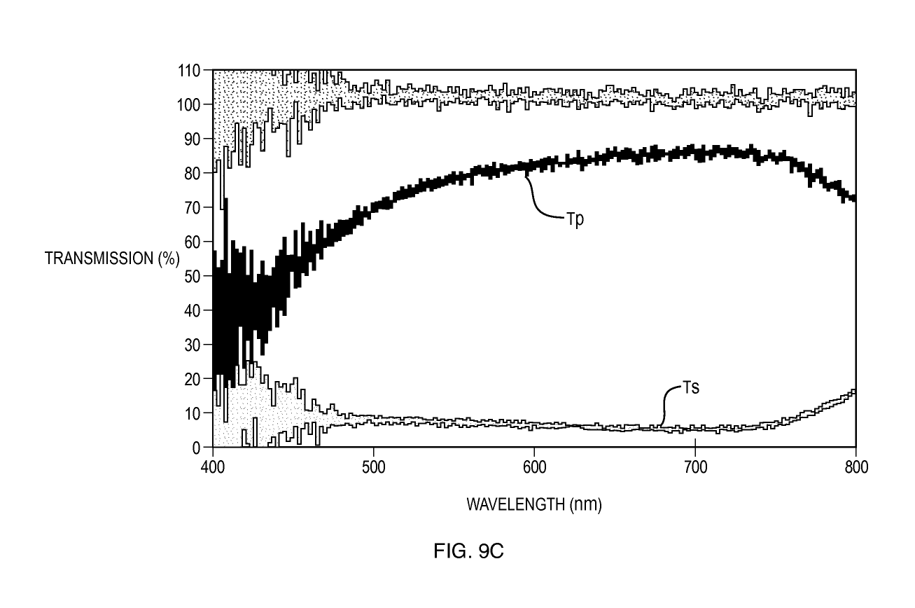

A FLUOROCUR® (FCR) mold of 180 nm pitch, 80 nm (or 135 nm) line height was fabricated from the Si master. A thin layer of silver nanoink was coated onto a PET substrate using a meyer rod. FCR mold was then laminated with the silver coated PET substrate. The PET substrate was then slowly peeled from the mold to allow dewetting and removal of flash layer. The silver ink filled FCR mold was then annealed in 150° C. (or another temperature as suggested by the silver nanoink manufacture) for at least 30 min. Optical performance of thus prepared NWGP was measured by spectrometer. The resulting optical performance showed dependence on the concentration, viscosity and particle size of silver nanoink used, as well as process parameters such as speed. The contrast of the thus prepared NWGPs showed a contrast ratio of 1˜40 and a transmission of Tp in the range of 70%˜90% at 700 nm. FIGS. 9A-9C show examples of the performance (Tp and Ts) for certain wavelengths of the as prepared NWGP (yellow Tp, pink Ts).

### Example 2

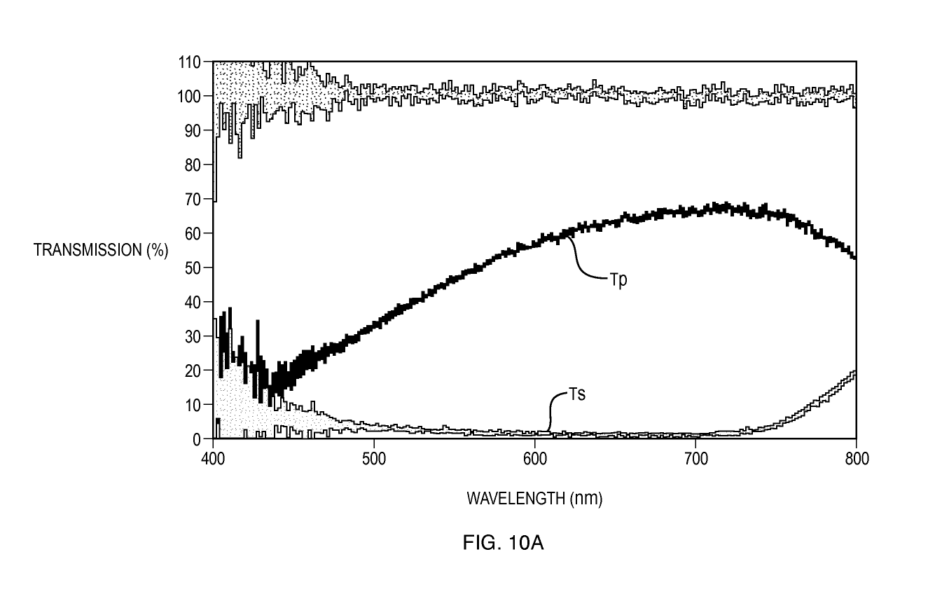

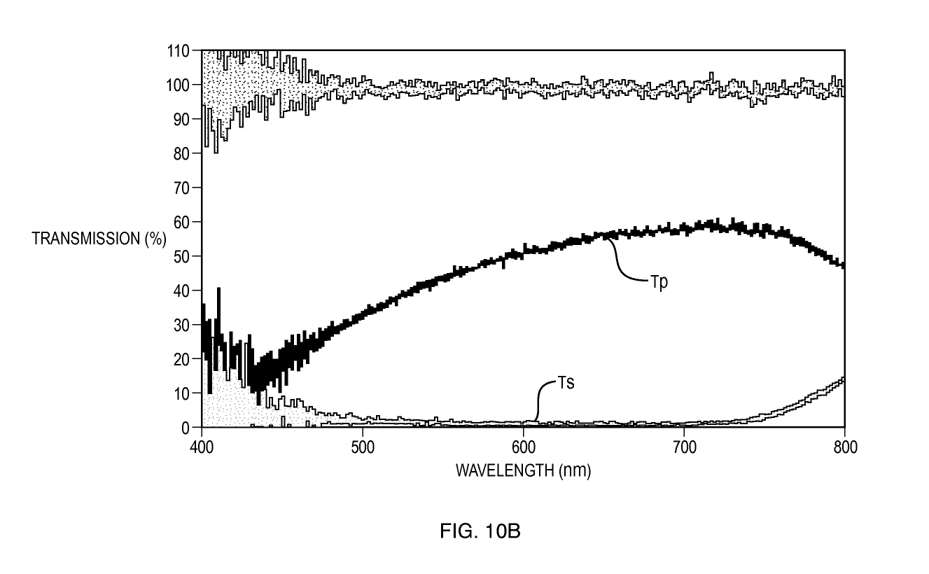

Similar to example 1, a NWGP was made by filling the FCR mold with silver nanoparticles and annealing at high temperature. To achieve higher contrast, thicker silver lines are needed. Therefore, the FCR mold was filled multiple times using the procedure described above and annealed at 150° C. Optical performance of thus prepared NWGP was measured by spectrometer. The resulting optical performance showed dependence on the concentration, viscosity and particle size of silver nanoink used, as well as process parameters such as speed. The contrast of the thus prepared NWGPs showed a contrast ratio of 30˜50 and a transmission of Tp in the range of 50%˜80% at 700 nm. FIGS. 10A-10B show some examples of the performance (Tp and Ts) for certain wavelengths of the NWGPs prepared by multiple filling passes.

### Example 3

A FCR mold of 180 nm pitch, 80 nm (or 135 nm) line height was fabricated from the Si master. A thin layer of silver nanoink was coated onto a PET substrate using a meyer rod. The FCR mold was then laminated with the silver coated PET substrate. The PET substrate was then slowly peeled from the mold to allow dewetting and removal of flash layer. The filled FCR mold was then annealed in 150° C. for at least 30 min. The patterned silver lines were then transferred to a PET or other substrate in the form of linear arrays by laminating the new substrate with the filled FCR mold and annealed at 150° C. Harvesting layer/material such as cyano acrylate, or norland optical resins can be applied between the filled FCR mold and the new substrate to improve transfer yield. Optical performance of thus prepared NWGP was measured by spectrometer. The resulting optical performance showed dependence on the concentration, viscosity and particle size of silver nanoink used, as well as process parameters such as speed and the transfer yield from FCR mold to the new substrate. The contrast of the thus prepared NWGPs showed a contrast ratio of 1˜30 and a transmission of Tp in the range of 50%˜90% at 700 nm.

### Example 4

The PRINT process was used to replicate a linear grating master (144 nm pitch, 70 nm linewidth, height 200 nm) into a UV-curable resin onto a polymer film substrate such as polyethylene terephthalate (PET). The substrate thicknesses range from 2 mil to 7 mil. In a preferred embodiment of the invention, the orientation of the grating lines is aligned with the birefringence axis of the PET substrate. The fluoropolymer mold used for this replication was formulated to have sufficient modulus to prevent collapse of the lines during the replication process, and sufficiently low surface energy to facilitate clean release from the master and from the UV-cured replicate. The nanopatterned replicate was then placed in a vacuum chamber and aluminum was deposited at oblique angle onto the corrugated surface by electron beam evaporation. The source-to-target distance was >0.5 m and the deposition angle was selected between 0 degrees (normal incidence) and 60 degrees. The deposition rate was 0.1-0.5 nm/sec and the deposited thicknesses ranged from 20-60 nm. The devices were then subjected to etching at room temperature for 0-8 min in a dilute buffered etch containing phosphoric and nitric acids. The devices were quenched in DI water, rinsed in isopropanol, and dried under a stream of dry nitrogen.

Devices made in accordance with this example having a metallized linear grating pattern with 144 nm pitch after etching are shown in FIGS. 13A-D. FIG. 13A shows an oblique view of an example structure near the ends of the lines. FIG. 13B shows a top view of an example structure. FIG. 13C shows a cross-sectional view of an example structure, wherein the grating substrate is at the bottom and the metal wires appear as caps or apostrophe shaped (light areas). FIG. 13D is a high magnification cross-sectional view of the structures in FIG. 13C with a schematic inset of the actual structure showing a geometrical unit cell used for electromagnetic simulations.

The performance of devices made in accordance with this example at visible wavelengths was measured using an optical spectrometer. The transmission of the two orthogonal polarizations (Tp, Ts) and the contrast ratio (Tp/Ts) as a function of wavelength showed strong dependence on the detailed shape of the underlying gratings, the metal deposition parameters, and the duration of the post-deposition etch. The use of etching raises Tp significantly without a significant drop in contrast.

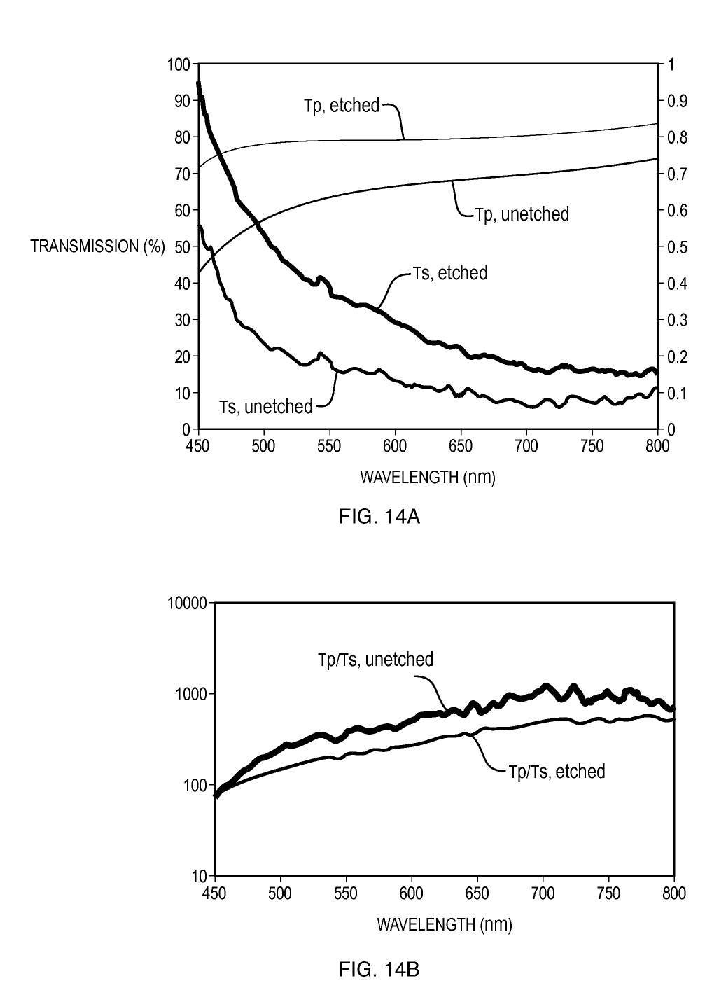

FIGS. 14A-B show some examples of the performance of certain devices made in accordance with this example. FIG. 14A shows the transmission spectra obtained from example etched and un-etched 144 nm linear grating patterns metallized by oblique evaporation. Tp (upper two curves) is on the left vertical axis (scale=% transmission with no sample) and Ts (lower two curves) is referred to the right axis (scale=%). For both sets, the transmission increases with etching. FIG. 14B shows contrast ratio (Tp/Ts) for un-etched (dark, upper curve) and etched (light, lower curve). For both graphs, the bottom horizontal axis is wavelength in units of nm.

### Example 5

The samples were prepared as in Example 4, but using cyclic olefin polymer (COP) film as the substrate. Orientation of the grating lines is not required for COP film. The COP substrate was corona-treated to obtain good adhesion to the UV-curable resin. For COP substrate, the optical performance of the final devices is slightly superior (Tp is 2-3 percent higher relative to that for PET) to those devices fashioned from PET substrate.

### Example 6

The samples were prepared as in Example 4, but in a process where PRINT technology is integrated into a continuous (roll-to-roll) manufacturing process. A cylindrical tool containing the nanoscale grating pattern was fashioned from Fluorocur material, and used to directly pattern the UV-curable resin onto 2 mil thick PET web at speeds up to 32 ft/min. Samples were metallized and etched in the same way as described in Example 4. The optical performance of device films prepared in this way was equivalent to that from device films prepared using the method of Example 4.

### Example 7

A Fluorocur mold was made from a linear grating master, with a structure of 144 nm pitch, 50% duty cycle, and 200 nm height lines. Using this mold a linear grating template was made through curing a UV curable resin, trifunctional acrylic ester from Sartomer, SR9012, on 5 mil thick polyethylene terephthalate (PET) film. The template was corona treated for 1 minute at room temperature to improve the surface compatibility. The patterned surface was then sensitized by absorbing the silver ions and then reducing to metallic silver on the surface. First the template was dipped into a an aqueous solution of silver nitrate (1 M) for 3 minutes and rinsed briefly with DI water followed by a nitrogen blow drying. Then it was dipped into an aqueous solution of 10 mM sodium borohydride for 1 minute, rinsed with DI water and blown dry with nitrogen. These steps were repeated two more times to generate silver nuclear sites for silver deposition in electroless plating. Silver electroless plating was performed as follows: An aqueous silver-ammonia solution (˜0.1 M) was mixed with glucose solution (1.9 M in a mixture of methanol/water, 3:7 vol/vol). The surface sensitized template was immersed in this mixture for 5 minutes. The template was taken out and washed with DI water and blown dry with nitrogen. The optical performance was measured on a spectrometer.

### Example 8

The silver plated template was made in the same way at example 7. The template was then etched using CHF3 plasma (RF power 300 w, at pressure 30 mT, CHF3 flow of 40 sccm, 1 minute) to remove the silver on the top of the lines and in the valleys, leaving silver wires on either side of the polymer grid lines. The transmission of the P-polarized light increased significantly while the transmission of the S-polarized light remained very low after RIE etch.

While the invention has been described with respect to particular embodiments, modifications and substitutions within the spirit and scope of the invention will be apparent to those of skill in the art. It should be apparent that individual elements identified herein as belonging to a particular embodiment may be included in other embodiments of the invention. The present invention may be embodied in other specific forms without departing from the central attributes thereof. Therefore, the illustrated and described embodiments and examples should be considered in all respects as illustrative and not restrictive, reference being made to the appended claims to indicate the scope of the invention.

1. A polarizer comprising:
a substrate sheet configured with grid elements on at least a first surface, wherein the grid elements have a height to width aspect ratio of at least 1.5:1; and
metal coupled with the grid elements, wherein the metal comprises a height to width aspect ratio greater than the aspect ratio of the grid elements of the substrate sheet.

2. The polarizer of claim 1, wherein the aspect ratio of the grid elements of the substrate sheet is greater than about 2:1.

3. The polarizer of claim 1, wherein the aspect ratio of the grid elements of the substrate sheet is greater than about 3:1.

4. The polarizer of claim 1, wherein the aspect ratio of the grid elements of the substrate sheet is greater than about 4:1.

5. The polarizer of claim 1, wherein the polarizer comprises a footprint of greater than about 900 square centimeters.

6. The polarizer of claim 5, wherein the polarizer comprises a plurality of polarizers and a seam between adjacent polarizers is less than about 500 nm horizontally and less than about 500 nm vertically.

7. The polarizer of claim 5, wherein the polarizer comprises a plurality of polarizers and a seam between adjacent polarizers comprises a feathered seam having a transition zone of greater than about 10 micrometers.

8. The polarizer of claim 1, wherein the grid elements of the substrate sheet are configured between about 5 degrees from vertical and 50 degrees from vertical.

9. (canceled)

10. A process for forming a polarizer comprising:
providing a mold;
fabricating a replicate inverse structure of the mold into a substrate material, wherein the replicate inverse structure comprises grid elements having a height to width aspect ratio of greater than about 1.5:1 and a pitch less than about 150 nanometers; and
metalizing the grid elements such that the metalized portion of the grid elements has a height to width aspect ratio greater than the aspect ratio of the grid elements.

11. The process of claim 10, wherein the mold comprises a patterned drum including a structure to be inversely replicated onto the substrate material.

12. A process for forming a polarizer comprising:
providing a substrate sheet; and
molding onto at least one surface of the substrate sheet at least two metal based grid elements comprising a height to width aspect ratio greater than about 2:1 and a pitch of less than about 150 nanometers.

13. The process of claim 12, wherein molding comprises:
providing a patterned template having a pattern;
depositing a metal solution into the pattern on the patterned template;
hardening the metal solution in the pattern on the patterned template to form the metal based grid elements; and
removing the patterned template from the grid elements.

14. The process of claim 13, wherein the patterned template comprises a web based mold or a patterned drum.

15. An infrared reflecting device comprising:
a first set of grid elements, wherein the grid elements of the first set comprise metal and have a height to width aspect ratio of greater than about 1.5:1 and a pitch between about 500 nanometers and about 1000 nanometers;
a second set of grid elements, wherein the grid elements of the second set comprise metal and have a height to width aspect ratio greater than about 1.5:1 and a pitch between about 500 nanometers and about 1000 nanometers; and
wherein the first set of grid elements are positioned orthogonal to the second set of grid elements such that the device is configured to reflect infrared radiation.

16. The device of claim 15, wherein the first set of grid elements are configured on a first substrate and the second set of grid elements are configured on a second substrate.

17.-19. (canceled)

20. The process of claim 10, wherein the mold comprises a polymer mold on a web.
